(19) United States
(12) Patent Application Publication
(10) Pub. No.: US 2006/0095518 A1
(43) Pub. Date: May 4, 2006

(54) Software application for modular sensor network node

(76) Inventors: Jesse Harper Zehring Davis, Berkeley, CA (US); Douglas Paul Stark JR., Tracy, CA (US); Nicholas Edmonds, Bloomington, IN (US)

Correspondence Address: Michael A. Rahman, Esq.;DORSEY & WHITNEY LLP, Suite 3400, 1420 Fifth Avenue, Seattle, WA, 98101, US

(21) Appl. No.: 10/970,684

(22) Filed: Oct. 20, 2004

(51) Int. Cl. G06F 15/16

(52) U.S. Cl. 709/206

(57) ABSTRACT

A software application enables communication among a plurality of modules in a modular sensor network node. The modular sensor node senses a parameter from the surrounding environment and generates data representative of the sensed parameter. The software application resides in each of the plurality of modules and includes program codes for transmission and reception of messages among the modules. The software application includes program codes that process the data to generate outgoing messages, transmit the outgoing messages over a communication bus coupled to the plurality of modules, and receive and process incoming messages.

### STATEMENT REGARDING RESEARCH & DEVELOPMENT

This invention was made with Government support under government contract no. DE-AC04-94AL85000 awarded by the U.S. Department of Energy to Sandia Corporation. The Government has certain rights in the invention, including a paid-up license and the right, in limited circumstances, to require the owner of any patent issuing in this invention to license others on reasonable terms.

### TECHNICAL FIELD

The present invention relates generally to modular sensor network nodes, and more specifically to a software application for efficient communication among modules in a modular sensor network node.

### BACKGROUND OF THE INVENTION

Sensor network nodes are used in many applications. For example, sensor network nodes are used to monitor: seismic activities; atmospheric pressure, temperature and humidity; indoor and outdoor agriculture to increase yield; environmental variation on a fine grained scale; vibration in factories to predict machine failures; a ship's hull for cracks in a distributed fashion; and HVAC systems in large office buildings.

FIG. 1 is a block diagram of a conventional sensor network 100. The sensor network 100 can be used in many applications such as, for example, detection of sound, radiation, pollution, etc. The sensor network 100 includes a plurality of nodes 104, 108, 112, and 116. The nodes 104-116 communicate with each other wirelessly. The sensor network 100 includes a base station 120 that communicates with the nodes 104-116 wirelessly. Alternatively, the nodes 104-116 and the base station 120 can be linked by a communication link such as a wire-line link, an optical link, the Internet or any other type of communication link.

The nodes 104-116 monitor their environment for data collection or event or object detection purposes. The nodes 104-116 may process and analyze the data to evaluate the event or the object. The nodes 104-116 can also transmit collected data to the base station 120 for analysis or storage.

FIG. 2 is a block diagram of a modular sensor node 200 that can be used as one of the nodes 104-116 of FIG. 1. The node 200 includes a system bus 204 that couples one or more modules to the node 200. The node 200 has a modular architecture because it includes one or more modules that can generally be added or removed from the node 200. As will be described later, the modules perform designated tasks and also communicate with one another over a communication bus (not shown in FIG. 2) that is a part of the system bus 204. The communication bus may include a high bandwidth data bus to carry data and a low bandwidth control bus to carry control signals.

The node 200 includes a processing module coupled to the system bus 204. The processing module 208 includes a general purpose processor 212 such as a microprocessor. The general purpose processor 212 performs complex processing tasks such as data processing and analysis related to an event, an object or the environment. The general purpose processor 212 functions as a shared resource for all other modules in the node 200. Other modules in the node 200 may request the processing module 208 to perform tasks that the other modules do not have the resources to perform.

The node 200 also includes a communication module 216 connected to the system bus 204. The communication module 216 includes a transceiver 220, which may be an optical, a wireless, a wire-line, or any other type of transceiver. The transceiver 220 allows the node 200 to communicate with other nodes in the network or the base station 124 (shown in FIG. 1).

The communication module 216 performs all necessary functions required to allow the node 200 to communicate with other nodes in the network and also with the base station, thus allowing the other modules in the node 200 to completely rely on the communication module 216 for all external, i.e. off-node, communications needs. Additionally, the communication module 216 performs network related tasks such as, for example, routing network traffic not intended for the node 200 without involving the other modules in the node 200, thus allowing the other modules in the node 200 to be undisturbed by network related events that do not concern the other modules.

The node 200 also includes a sensor module 224 that is connected to the system bus 204. The sensor module 224 includes a sensor 228 designed to sense or detect parameters such as, for example, sound, seismic activities, images or other parameters. The sensor 228 may also be designed to detect chemical or biological agents or radiation or any other parameters that can be sensed. If the application requires, the node 200 can have a plurality of sensor modules. The sensor module 224 includes a resource specific processor 230 that controls and manages the sensor 228. The sensor module 224 may also be capable of storing a small number of data from sensor readings.

The node 200 also includes a power supply module 232 that is connected to the system bus 204. The power supply module 232 provides power to the various modules of the node 200 via the system bus 204. The power supply module 232 includes one or more regulated power supplies 336 that provide one or more regulated voltages.

As described above, during operation the modules 208-232 each perform some designated tasks and also communicate with one another in order to process the sensed information. The modules 208-232 require software applications that assist the modules 208-232 to perform the designated tasks. The modules 208-232 also require software applications that allow the modules 208-232 to communicate with one another. More specifically, the modules 208-232 require software applications that allow the modules 208-232 to transmit and receive messages including data and requests for processing. The modules 208-232 require software applications to enable the modules 208-232 to interface with the system bus 204.

Accordingly, there is a need for a software application that assists the modules 208-232 to perform the designated tasks, allows the modules 208-232 to communicate with one another, and allows the modules 208-232 to interface with the system bus 204.

### SUMMARY OF THE INVENTION

The present invention is directed to a software application that enables communication among a plurality of modules in a modular sensor network node. The modular sensor node senses a parameter from the surrounding environment and generates data representative of the sensed parameter. The software application resides in each of the plurality of modules and includes program codes for transmission and reception of messages among the modules. The software application includes program codes operable to process the data to generate outgoing messages, to transmit the outgoing messages over a communication bus coupled to the plurality of modules, and to receive and process the incoming messages.

The software application also includes an integrity check code that receives the outgoing messages and checks the integrity of the outgoing messages prior to the transmission over the communication bus. The software application also includes a fragmentation code that receives the outgoing messages and fragments the messages prior to the transmission over the communication bus. The software application also includes a reassembly code that receives the fragmented messages and reassembles the fragmented messages and processes the reassembled messages. The software application also includes an identification code that determines the identity of the plurality of modules in the sensor node and informs the identities of the plurality of modules to all the modules.

### BRIEF DESCRIPTION OF THE DRAWINGS

FIG. 1 is a block diagram of a conventional sensor network.

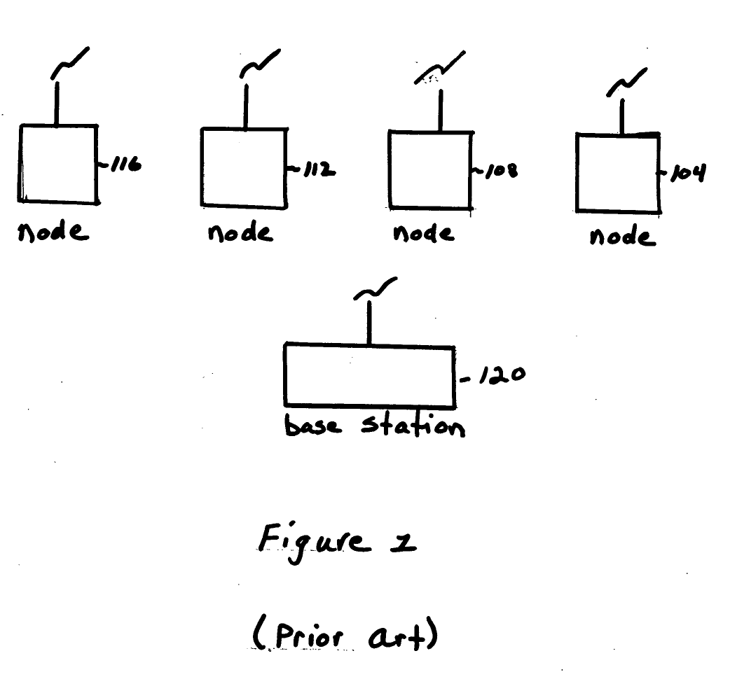

FIG. 2 is a block diagram of one of the nodes of FIG. 1 in more detail.

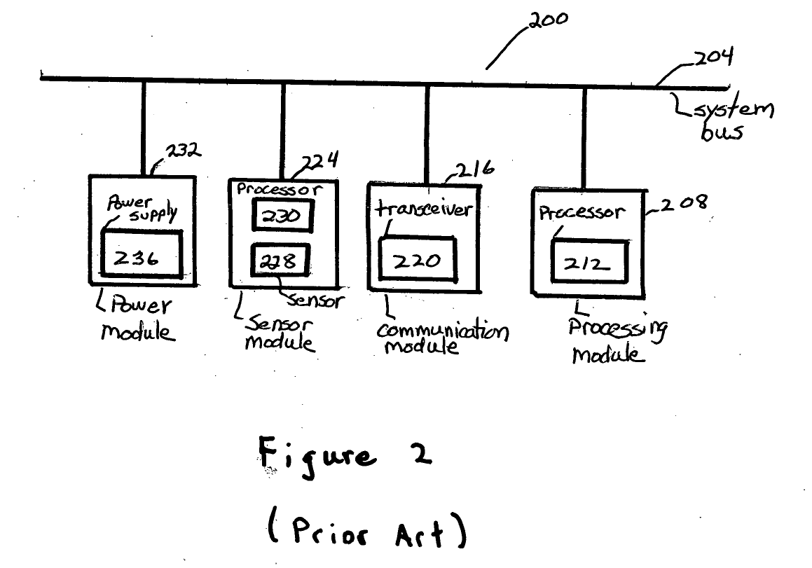

FIG. 3 illustrates an architecture of a software application in accordance with one embodiment of the invention.

FIG. 4 is a flow diagram of the steps involved in the transmission and reception of data.

### DETAILED DESCRIPTION OF PREFERRED EMBODIMENTS

The various features and embodiments of the software application will now be described in the context of a modular sensor network node. Those skilled in the art will recognize that the software application can be used in other types of sensor network nodes.

Throughout the description of the software application, implementation-specific details will be given on how the software application is used. These details are provided to illustrate the preferred embodiments of the software application and not to limit its scope.

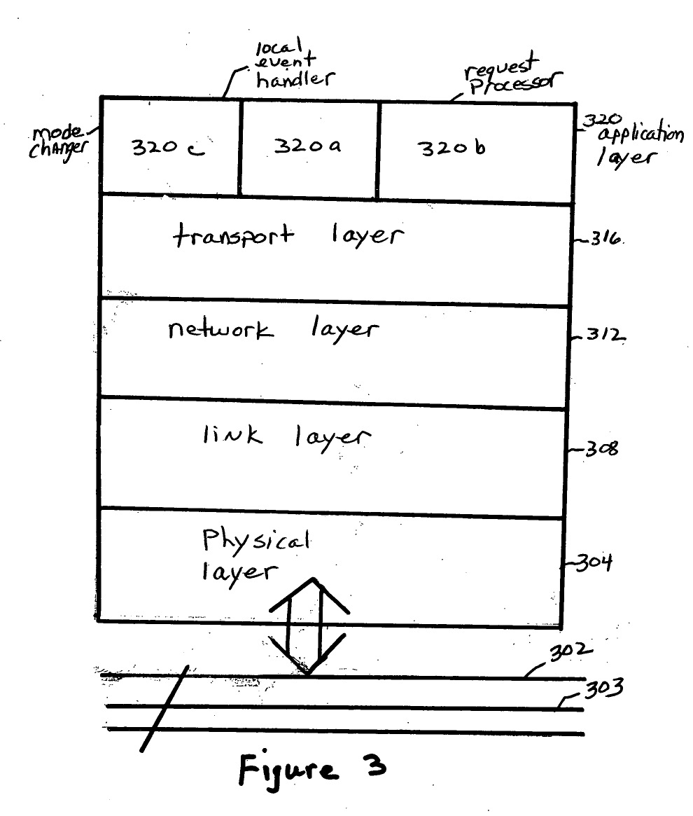

FIG. 3 illustrates an architecture of a software application 300 in accordance with one embodiment of the invention. In one embodiment of the invention, the software application 300 resides in all the modules of a sensor node, and allows the modules to communicate with one another over a system bus 302. The system bus 302 generally includes a communication bus 303 that carries data and other messages.

As will be described in more detail later, the software application 300 includes several layers, each layer containing program codes for executing transmission and reception of messages including data by the modules. The software application 300 allows the modules in the sensor node to communicate with other nodes in a network, or allows the modules to communicate with a base station.

Before describing the layers (i.e., program codes) of the software application 300, the structure of messages between the modules and between the layers will be briefly discussed. In one embodiment of the invention, the messages have the following structure:

struct Message
{

INT8U to;
INT8U from;
INT8U flags;
INT8S prio;
INT8U msgID;
INT8U cmd;
INT16U dataLength;
INT8U* dataPtr;

};

The to and from fields are the destination and source of the message, respectively. The flags field is used to indicate fragmentation of the message into smaller messages, the prio field denotes the priority of the message if relevant, msgID uniquely identifies a message within a module, cmd indicates the type of the message, and dataLength specifies the amount of data contained in the data pointer, dataptr. The fields described above are referred to as the “header.” The actual data included in the message, if any, is contained in the data pointer.

In one embodiment, communication between layers in the software application 300 and between the modules occurs via prioritized queues. The priority queue structure allows messages to be processed based on their respective priorities. If a queue is full, a message is inserted in a queue if it is higher in priority than any other on the queue, and the lowest priority message is removed. In the case of a tie between lowest priorities, the oldest message is removed.

Referring back to FIG. 3, the software application 300 includes a physical layer 304 that interfaces directly with the communication bus 303 and controls transmission and reception of individual bytes of data across the communication bus 303. As described before, the communication bus 306 is part of the system bus 302 that links the modules of the sensor node.

In one embodiment, the physical layer 304 buffers one message for transmission over the communication bus 303. Once the physical layer 304 has buffered a message for transmission, the physical layer 304 rejects requests to send additional messages until the buffered message is transmitted.

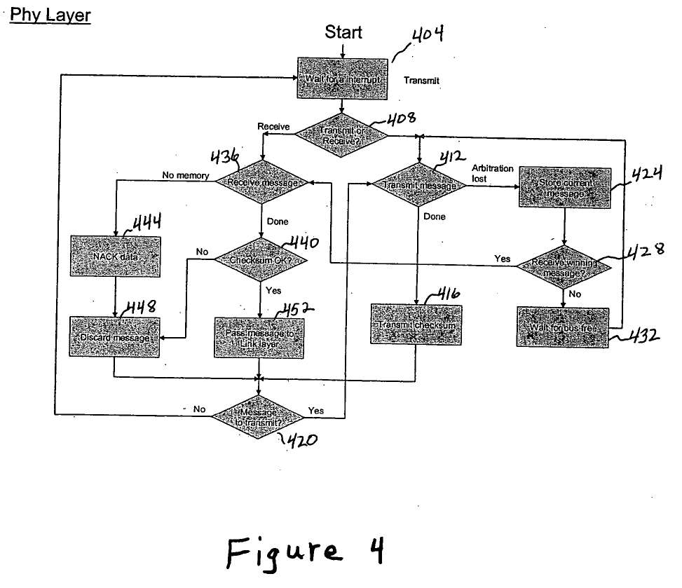

FIG. 4 is a flow diagram of the steps involved in the transmission and reception of data by the physical layer 304. In step 404, the physical layer 304 waits for an interrupt signal. As will be understood by those skilled in the art, the interrupt signal alerts the physical layer 304 that a message is waiting to be transmitted or to be received.

In step 408, the physical layer 304 determines if the message is to be transmitted or to be received. If the message is to be transmitted, in step 412 the physical layer 304 initiates the transmission by determining if the bus is free or busy. If the bus is busy, i.e., another message is being transported by the bus, the physical layer 304 waits until the bus is free to transmit the message. In some cases, two modules may attempt to transmit messages at the same time causing a collision.

When two messages collide during transmission over the bus, an arbitration logic in the physical layer 304 selects a winner and a loser of the arbitration. The arbitration logic allows the sender of the winning message to transmit uninterrupted while the other sender of the losing message waits until the bus is free before retransmitting. The loser of the arbitration is able to receive the winning message, if necessary.

If the bus is free, the physical layer 304 sends the content of the message. In step 416, the physical layer 304 transmits a checksum that allows the recipient of the message to determine if the entire message has been received correctly. In one embodiment, as each byte of data is received, the recipient calculates the checksum. If the calculated checksum matches the received checksum, the recipient accepts the message. If the calculated checksum does not match the received checksum, the message is discarded by the recipient.

In step 420, the physical layer 304 determines if there are additional messages to be transmitted. If there are additional messages to be transmitted, the flow returns to step 412, and if there are no additional messages to be transmitted, the flow returns to step 404.

If the physical layer 304 loses the arbitration in step 412, the message is stored in the module in the physical layer 304 in step 424. In step 428, the physical layer 304 decides if the winning message was received. If the winning message was not received, the flow moves to step 432 where the physical layer waits for the bus to be free. If the winning message was received, the physical layer 304 executes steps for reception of messages that will be discussed below.

If in step 408, a message is to be received, the flow moves to step 436. If there is enough memory available in the module to store the message, the message is received and the flow moves to step 440 where it determined if the checksum is correct. If the checksum is correct (i.e., the calculated checksum matches the received checksum), the physical layer forwards the message to a link layer 308. If the checksum is not correct, the message is discarded in step 448. If the physical layer 304 cannot secure enough memory to store the incoming message, incoming bytes are NACKED (i.e., the physical layer 304 sends a “not acknowledged” signal) in step 444 and the message is discarded in step 448.

The link layer 308 resides above the physical layer 304, and checks the integrity of the messages transmitted by the physical layer 304. The integrity check ensures that corrupted or invalid messages are not transmitted by the physical layer 304. For example, a message to and from the same node or a message that claims to contain 80 bytes of data but has a null pointer will be rejected by the link layer 308. If the message passes the integrity check, the link layer 308 forwards the message for transmission by the physical layer 304. The link layer 308 also receives messages from the physical layer 304 and forwards the messages to a network layer 312.

The network layer 312 resides above the link layer 308, and informs the modules of each other's existence and keeps track of all modules in the node. In one embodiment, the network layer 312 manages the addressing of outgoing messages, i.e., filling in the “to” and “from” fields. If a message is not addressed to a particular module, or specified to be a broadcast, a default routing scheme is used to address the message. In one embodiment, the default routing scheme sends the message to any available general purpose processor module, and if it finds none, to a communication module.

In one embodiment, the network layer 312 sends heartbeat messages, also referred to as IDBroadcast messages to all modules in the node. The IDBroadcast message identifies a module to other modules in the node. The IDBroadcast message contains the module's address and type information. The network layer 312 also keeps track of heartbeat messages received from other modules to determine when other modules enter and leave the node.

In one embodiment, the network layer 312 performs address determination and resolves address conflicts. The network layer 312 generates a random number to serve as the address of the module, and generates a new address if the previous address is already in use. If the network layer 312 receives an IDBroadcast message that identifies another module as having the same address as the module attached to the network layer 312, the network layer 312 sends an IDContention message to the other module. As will be understood by those skilled in the art, the IDContention message is used to resolve a conflict that arises when a module identifies itself with an address that is already in use. The IDContention message informs the module that it needs to generate a new address. In response, the module generates a new address and sends an IDBroadcast message. This process repeats itself until all modules in the node have unique addresses. The network layer 312 forwards messages other than IDBroadcast and IDContention messages received from other modules to a transport layer 316.

The transport layer 316 resides above the network layer 312. The transport layer 316 handles fragmentation of large messages to prevent tying up the communication busses for long periods of time.

In one embodiment, the transport layer 316 breaks messages whose total size is greater than a predetermined number of bytes into several smaller messages. The message header and part of the data are copied into each small message which is then sent to another module. The small messages are reassembled into the original large message by the transport layer on the destination module.

In one embodiment, the transport layer receives only one fragment of a message, i.e., a small message, at a time. The flags field is used to reassemble the small messages into a large message. If a complete packet (i.e., all small messages comprising a large message) is not received within a predetermined time limit, the received small messages are discarded. The transport layer 320 forwards the outbound fragmented messages to the network layer 312, and also forwards the inbound reassembled messages to an application layer 320.

The application layer 320 resides above the transport layer 316. In one embodiment, the application layer 320 consists of three functional units: a local event handler 320a, a request processor 320b, and a mode changer 320c.

In one embodiment, the local event handler 320a sends requests from its attached resource (e.g., a sensor module) to another module, and returns the responses to the requests to the attached resource. For example, the local event handler 320a may be attached to a sensor, and may send a request to a processor module to analyze data. The local event handler 320a accepts processing requests from the attached resource and enters the requests in a list of outstanding requests. The local event handler 320a sends the request to another module in the node and waits for a response. If the request is unanswered by another module more than a predetermined number of times or is bumped from another module's queue more than a predetermined number of times, the request is dropped by the local event handler 320a. Once a request is accepted by another module, the local event handler 320a waits for the request to be processed and also waits for the result to be returned to the requesting module. When a result is successfully received, the request is removed from the list and the result is returned to the attached (i.e., requesting) resource.

In one embodiment, while the request is processing or waiting to be processed on another module, the local event handler 320a checks up on the request by sending status requests to the other module. Thus, the local event handler 320a keeps track of the status of the request and can provide the attached resource with updated information. If a request is bumped out of the other module's queue, that module sends a request bumped message to the local event handler 320a.

The request processor 320b handles processing requests from other modules. For example, the request processor 320b if attached to a processing module may accept processing requests from other modules. The request processor 320b maintains a prioritized list of processing requests from other modules. When the requests are completed, the request processor 320b sends the results to the requesting module.

The mode changer 320c allows the module to conserve power. For example, the mode changer 320c manages the sampling rate of the sensor in a sensor module to conserve power. Each sample taken by the sensor generally represents a constant amount of energy expended. The mode changer 320c adapts the sample rate to an expected number of events in the surrounding environment to help minimize power consumption for a particular application. Some sensor nodes may be equipped with a wireless network connector in which a transceiver actively listens to a channel during certain time periods and may completely power down the rest of the time. The mode changer 320c manages when and for what duration the transceiver is actively listening to a channel.

In one embodiment, the mode changer 320c alters the attached module's actions based on the node's configuration. Since the network layer 312 maintains information about the other modules in the node, the mode changer 320c uses this information to control the resources more intelligently. For example, in a node where there is only a sensor module and a power supply module, the mode changer 320c may simply store collected data without trying to send the data for processing to a nonexistent general purpose processor.

The mode changer 320c also schedules sleep times for the attached resource. For example, the mode changer 320c monitors the incoming request rate from other modules and determines the usage of an attached resource. If the resource is being used infrequently, the mode changer 320c switches the resource to a low power state after the resource completes processing all pending requests.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A software application residing in each of a plurality of modules in a modular sensor node for sensing a parameter from a surrounding environment and generating data representative of the sensed parameter, the software application configured to enable communication among the plurality of modules, comprising: program codes operable to process the data to generate outgoing messages, to transmit the outgoing messages over a communication bus coupled to the plurality of modules, and to receive and process the incoming messages.

2. The software application of claim 1 further comprising an integrity check code configured to receive the outgoing messages and operable to check the integrity of the outgoing messages prior to the transmission over the communication bus.

3. The software application of claim 1 further comprising a fragmentation code configured to receive the outgoing messages and operable to fragment the messages prior to the transmission over the communication bus.

4. The software application of claim 1 further comprising a reassembly code configured to receive the fragmented messages and operable to reassemble the fragmented messages and provide the reassembled messages for processing.

5. The software application of claim 1 further comprising an identification code operable to determine the identity of the plurality of modules in the sensor node and inform the identities of the plurality of modules to all the modules.

6. The software application of claim 1 further comprising an arbitration logic code operable to resolve conflicts caused by the transmission of a plurality of messages over the communication bus.

7. The software application of claim 1 wherein the program codes calculate the checksum of the incoming message to determine if the entire incoming message was received correctly.

8. The software application of claim 7 wherein the program codes forwards the incoming message for processing if the checksum is correct.

9. The software application of claim 1 wherein the program codes NACKs incoming messages when there is not enough memory in the module to store the incoming messages.

10. The software application of claim 5 wherein the identification code sends IDBroadcast messages to the plurality of modules identifying the particular module attached to the software application to the other modules.

11. The software application of claim 10 wherein the identification code sends an IDContention message when it receives an IDBroadcast message that identifies a another module having a same address as the particular module attached to the software application.

12. The software application of claim 3 wherein the fragmentation code breaks the message whose total size is greater than a predetermined size into a plurality of small messages, each small message having a header and a portion of the data from the original message.

13. A software application residing in each of a plurality of modules in a modular sensor node for sensing a parameter from a surrounding environment and generating data representative of the sensed parameter, the software application configured to enable communication among the plurality of modules, the software application comprising:
a first program code configured to receive the data and operable to process the data to generate outgoing messages;
a second program code configured to receive the outgoing messages from the first program code and operable to transmit the outgoing messages over a communication bus coupled to the plurality of modules, the second program code configured to receive incoming messages and operable to provide the incoming messages to a third program code operable to process the incoming messages.

14. The software application of claim 13 further comprising an integrity check code configured to receive the outgoing messages from the first program code and operable to check the integrity of the outgoing messages prior to the transmission over the communication bus.

15. The software application of claim 13 further comprising a fragmentation code configured to receive the outgoing messages from the first program code and operable to fragment the messages prior to the transmission over the communication bus.

16. The software application of claim 13 further comprising a reassembly code configured to receive the fragmented messages and operable to reassemble the fragmented messages and provide the reassembled messages to the third program code for processing.

17. The software application of claim 13 further comprising an identification code operable to determine the identity of the plurality of modules in the sensor node and inform the identities of the plurality of modules to all the modules.

18. The software application of claim 13 further comprising an arbitration logic code operable to resolve conflicts caused by the transmission of a plurality of messages over the communication bus.

19. The software application of claim 13 wherein the second program code calculates the checksum of the incoming message to determine if the entire incoming message was received correctly.

20. The software application of claim 19 wherein the second program code forwards the incoming message to the third program code for processing if the checksum is correct.

21. The software application of claim 13 wherein the second program code NACKs incoming messages when there is not enough memory in the module to store the incoming messages.

22. The software application of claim 17 wherein the identification code sends IDBroadcast messages to the plurality of modules identifying the particular module attached to the software application to the other modules.

23. The software application of claim 22 wherein the identification code sends an IDContention message when it receives an IDBroadcast message that identifies a another module having a same address as the particular module attached to the software application.

24. The software application of claim 15 wherein the fragmentation code breaks the message whose total size is greater than a predetermined size into a plurality of small messages, each small message having a header and a portion of the data from the original message.

25. A sensor network comprising:
a plurality of sensor nodes connected to each other over a communication link;
a base station in communication with the sensor nodes via the communication link;
wherein each sensor node further comprises at least one sensor module coupled to a system bus and configured to sense a surrounding parameter and operable to generate data representative of the sensed parameter, each sensor module further includes a software application configured to enable communication among a plurality of modules in the sensor node, the software application comprising: program codes operable to process the data to generate outgoing messages, to transmit the outgoing messages over a communication bus coupled to the plurality of modules, and to receive and process the incoming messages.

26. The sensor network of claim 25 wherein the software application further comprises an integrity check code configured to receive the outgoing messages and operable to check the integrity of the outgoing messages prior to the transmission over the communication bus.

27. The sensor network of claim 25 wherein the software application further comprises a fragmentation code configured to receive the outgoing messages and operable to fragment the messages prior to the transmission over the communication bus.

28. The sensor network of claim 25 wherein the software application further comprises a reassembly code configured to receive the fragmented messages and operable to reassemble the fragmented messages and provide the reassembled messages for processing.

29. The sensor network of claim 25 wherein the software application further comprises an identification code operable to determine the identity of the plurality of modules in the sensor node and inform the identities of the plurality of modules to all the modules.

30. A method of communication among a plurality of modules in a sensor node configured to sense a surrounding parameter and generate data representative of the sensed parameter, comprising:
receiving the data and generating outgoing messages for processing the data;
transmitting the outgoing messages over a communication bus coupled to the plurality of modules;
receiving incoming messages and providing the incoming messages for processing the incoming messages.

31. The method of claim 30 further comprising checking the integrity of the outgoing messages prior to the transmission over the communication bus.

32. The method of claim 30 further comprising fragmenting the outgoing messages prior to the transmission over the communication bus.

33. The method of claim 32 further comprising: receiving and reassembling the fragmented messages; processing the reassembled messages.

34. The method of claim 30 further comprising:
determining the identity of the plurality of modules in the sensor node; informing the identities of the plurality of modules to all the modules.

35. The method of claim 30 further comprising resolving conflicts caused by the transmission of a plurality of messages over the communication bus.

36. The method of claim 30 further comprising calculating the checksum of the incoming message to determine if the entire incoming message was received correctly.
